(19) United States
(12) Patent Application Publication
(10) Pub. No.: US 2024/0095354 A1
(43) Pub. Date: Mar. 21, 2024

(54) ASSURANCE MODEL FOR AN AUTONOMOUS ROBOTIC SYSTEM

(71) Applicant: Worcester Polytechnic Institute, Worcester, MA (US)

(72) Inventors: Vincenczo DiLuoffo, Sandy Hook, CT (US); William R. Michalson, Douglas, MA (US)

(21) Appl. No.: 18/368,384

(22) Filed: Sep. 14, 2023

Related U.S. Application Data
(60) Provisional application No. 63/406,533, filed on Sep. 14, 2022.

(51) Int. Cl. G06F 21/55; G06N 7/01

(52) U.S. Cl. CPC G06F 21/554; G06N 7/01; G06F 2221/034

(57) ABSTRACT

A security assessment tool and application for an autonomous robotic systems utilizes a Bayesian Network for scoring each subsystem based on security-enabled features. Each subsystem layer may consist of the system, hardware, software, Al, and supplier elements in an autonomous robotic (or other) system. Each element is assessed on the basis of its trustworthiness (based on factors such as the integrity of the design process, the engineering process, followed by the assessment of the integrity of the supplier, and the like) as well as a weighting based on the criticality of that element to the correct operation of the system. Using these factors, a “belief’ in the assurance of the system is determined based on a Bayesian model. The Bayesian Network is used to determine an autonomous robotic systems' internal trust before that can be extended to an external entity.

### RELATED APPLICATIONS

This patent application claims the benefit under 35 U.S.C. § 119(e) of U.S. Provisional Patent App. No. 63/406,533, filed Sep. 14, 2022, entitled “ASSURANCE MODEL FOR AN AUTOOMOUS ROBOTIC SYSTEM” incorporated herein by reference in entirety.

### BACKGROUND

Robotic systems are expanding into or augmenting human roles. We have seen an increase in the number of autonomous vehicles, ride services, aerial and maritime vehicle companies. As these robotic systems are deployed in an essentially unbound environment, they are therefore more susceptible to adversarial attacks. Artificial Intelligence (AI) is enabling the progression of autonomous systems as we witness this with self-driving cars, drones, deep sea and space exploration. The increased level of autonomy provides new security exposures, which are different from conventional ones. As the Robot Operating System (ROS) has become a de facto standard for many robotic systems, the security of ROS becomes an important consideration for deployed systems. The original ROS implementations were not designed to mitigate the security risks associated with hostile actors. This shortcoming is addressed in the next generation of ROS, ROS 2 by leveraging DDS for its messaging architecture and DDS security extensions for its protection of data in motion.

### SUMMARY

A security assessment tool and application for an autonomous robotic systems utilizes a Bayesian Network for scoring each subsystem based on security-enabled features. Each subsystem layer may consist of the system, hardware, software, Al, and supplier elements in an autonomous robotic (or other) system. Each element is assessed on the basis of its trustworthiness (based on factors such as the integrity of the design process, the engineering process, followed by the assessment of the integrity of the supplier, and the like) as well as a weighting based on the criticality of that element to the correct operation of the system. Using these factors, a “belief’ in the assurance of the system is determined based on a Bayesian model. This Bayesian Network is used to determine an autonomous robotic systems' internal trust before that can be extended to an external entity.

A Bayesian network provides a model for internal cognitive assurance of an autonomous system by identifying and ranking or scoring a transition from a prior machine state to a current machine state, and evaluating a probability that the current machine state is indicative of a breach. In an example configuration, developing the model may include generating a set of nodes, such that each node of the set of nodes is indicative of a relevant state, and identifying a set of nodes indicative of a successive state. Security related events or threats result in an identifiable change in the state of one or more of the nodes corresponding to a non-intrusion condition. The model is invoked for comparing the generated set of nodes, generally a non-compromised state, with the nodes indicative of the successive state to identify a probability of a security intrusion existing in the successive state.

In presently available robotic systems, due to the complexity of evaluating the assurance of an autonomous robotic system, security tends to be assessed in an ad-hoc, piecemeal fashion that leaves potential security risks and vulnerabilities that can go unnoticed. Industrial robots are mostly used in the manufacturing environment where they were protected by physical barriers: walls and closed networks. However, autonomous robots, with a large array of sensors and open connectivity that span land, water, and air have no such physical barriers. Such systems will be the most susceptible to security vulnerabilities.

In further detail, in a particular configuration as described herein, the method for internal cognitive assurance of an autonomous system includes developing a model for identifying a transition from a prior machine state to a current machine state, and deploying the model in an autonomous system, such as an EV (Electric Vehicle) or mobile/wheeled robot. The model is invoked for evaluating a probability that the current machine state is indicative of a breach. Developing and deploying the model may further include generating a set of nodes, where each node of the set of nodes is indicative of a relevant state, and identifying a set of nodes indicative of a successive state. Comparison of the generated set of nodes with the nodes indicative of the successive state identifies a probability of a security intrusion.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of an autonomous robotic system;

FIG. 2 shows an example of a set of nodes;

FIG. 3 shows the sensor example of FIG. 2 with a CPT (Conditional Probability Table) defined for each node;

FIG. 4 depicts a distance metric for robustness;

FIG. 5 depicts an example BN that applies the trust metrics; and

FIG. 6 shows evaluation of a level of the BN of FIG. 5.

### DETAILED DESCRIPTION

Modern robots are constructed with sensors, controllers, communications, motors, hardware accelerators as well as software forming a cognitive layer for processing and controlling the robot. Autonomous robots are often fully autonomous, putting their software and hardware all in one location, providing an adversary with a complete system with little, if any, physical security.

This makes physical attacks on robots much easier than attacks on corporate managed computers, since systems are typically under system management and are physically protected by the building that houses them. As robots move from factory floors into society this physical protection is removed making systems more vulnerable.

To address security in robotic systems, operating systems such as ROS 2 with DDS (Data Distributed Services) security allows online data in-motion encryption with access control protection. DDS security is dependent on the OpenSSL library and on a security configuration file that specifies sensitive data location. DSS Security assumes that the underlying Operating System (OS) is secure and that the dependencies are consistent, but ongoing integrity checks are not performed. However, off-line and on-line exploits can involve software or hardware attacks, especially when robots are out in the wild. Research is in the early stages of investigating autonomous vehicle security, artificial intelligence and robotics while others are looking at the performance related to security and creating isolation containers from memory restrictions. However, these approaches tend to focus on individual security threats and ignore viewing the threat environment as a whole; that is, taking what configurations herein depict as a holistic approach to autonomous robot security.

Configurations herein address trust metric space related to evaluating systems, hardware components, software components, cognitive-layer robustness as well as vulnerabilities introduced in the supply chain and have come to realize that no conventional set of metrics for assessing system trust fully spans any system architecture, let alone autonomous robotic systems. The overall complexity of performing assessment and the complexity of identifying potential security problems are bad enough in a controlled environment; now add high-value targets in an unconstrained environment and they get much worse. Defining trust metrics for system security is difficult, leading many practitioners to only define metrics for small portions of an overall system. This approach, while making the assessment of a system more tractable, can result in security vulnerabilities being undetected. Existing approaches to evaluating trust rapidly become computationally intractable due to the large number of interrelated variables that must be considered. Thus, it would be beneficial to define an approach for evaluating trust of autonomous systems more computationally feasible.

Configurations discussed below define a solution that takes a number of the autonomous robotic system layers and brings them together to form a holistic trust model. This trust model is different from other approaches because we are proposing a complete solution from a security perspective, eliminating the gaps left by conventional techniques in the evaluation of system, hardware, and software layers. The disclosed model also includes AI robustness attributes and supply chain characteristics. The overall complexity of the space and the security problems are bad enough in a controlled environment, now add high-value targets in an unconstrained environment where they get much worse. The unconstrained environment makes the problem computationally intractable for conventional approaches. Thus, there is a need to develop a way to make assessment more computationally feasible.

A probabilistic approach to analysis using Bayesian Networks (BNs) provides a natural way to reason about uncertainty. BN-based models allow for efficient factorization of the set of system states, without the need for an explicit representation of the whole joint distribution; moreover, they have the additional advantage of inference algorithms available for the analysis of any posteriori situation of interest (i.e. evidence can be gathered by a monitoring system). Bayesian Inference simplifies the way to reason about a complex domain problem like security for autonomous robotic systems.

In order to represent an autonomous robotic system architecture and assess the security of it, we have discussed the different layers (system, hardware, software, Cognitive/AI, and supplier chain) as independent trust metrics. These individual trust metrics account for the different levels depending on the security features supported by the autonomous robotic system and may be expanded to cover other elements of importance.

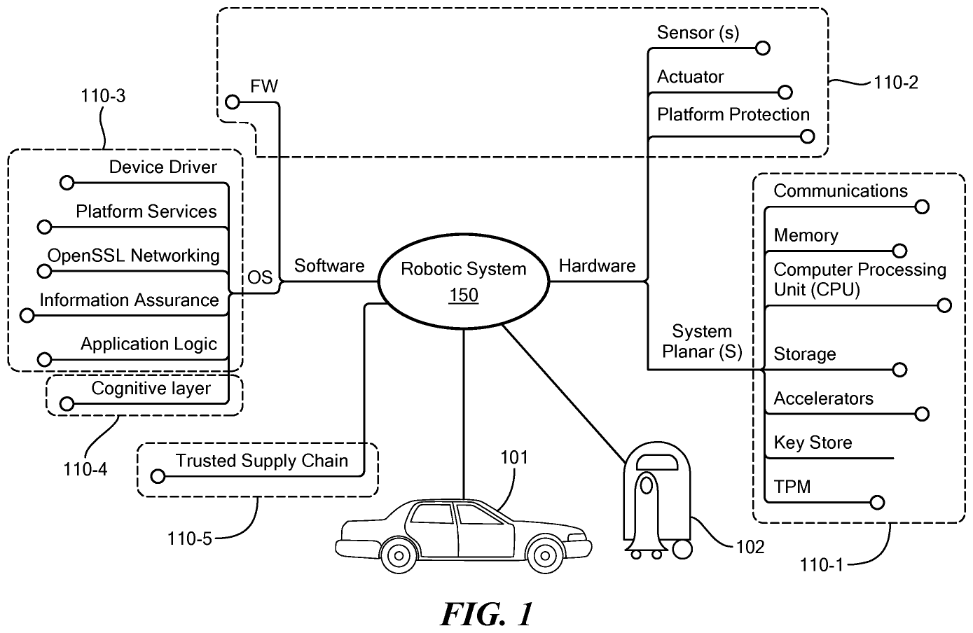

FIG. 1 is a context diagram of an autonomous robotic system suitable for use with configurations herein. Referring to FIG. 1, an autonomous robotic system 150 may be a self-driving vehicle 101 or a mobile robot 102. A particular vulnerability results where the autonomous system is often not constrained indoors by any kind of physical security, but rather includes an untethered robotic element in free space, such as roads, open air environments, public venues, etc. The robotic system includes a plurality of components, each of which can be assigned to one or more levels. These levels form dependencies in the BN as disclosed below. An example using the levels employed herein include the system 110-1, hardware 110-2, software 110-3, cognitive/AI 110-4 and supply chain 110-5. Any suitable arrangement of components to levels may be architected.

With each individual trust metric and its associated level, we also need to account for the collateral damage that may result from an attack on that part of the system, as well as the perceived target value of that element. In other words, we need to account for the adversary's actions and by combining these values with the trust metric we get the general probability equation:

TM=LV*AER*AED*ATA,

where TM=trust metric, LV=level value, AER=probability of adversary exploit reward and AED=probability of adversary exploit damage, ATA=likelihood of an adversary taking action to exploit. This general equation will be expanded in configurations below.

The combination of these values provides a set of metrics that can be assigned to each corresponding component in the system. The BN will provide the casual inference by linking these components and the values for the conditional probability tables. A full joint distribution is defined as the product of the conditional distribution. of each node. This is shown in the equation below where the left-hand side is the joint distribution, the center is the conditional probability (using the chain rule), and the right-hand side is the conditional probability given the parents.

$$P ( {x}_{1} … {x}_{n} ) = {\prod }_{i - 1}^{n} P ( {x}_{i} \vert {x}_{1} … {x}_{( i - 1 )} ) = {\prod }_{i - 1}^{n} P ( {x}_{i} \vert parents ( {x}_{j} ) )$$

In general, a trust metric for a given level is created as a function, fi, where fi=Factor 1*Factor 2* . . . *Factor N. The number of metric values is a function of the granularity of the analysis, and generally ranges from 3 to 7 with 5 being a reasonable tradeoff between resolution and complexity. From these factors, a trust metric, T, is derived by normalizing the fi over the range, so T=0≤|fi|≤. 1.

For example, at the system level trust metric, we start with the related Evaluation Assurance Levels (EALs) of 1 to 5 levels and combine them with cost/reward/likelihood values, this provides five levels for the system metric and each having a cost/reward/likelihood value, then that is normalized:

STn=EALn*AERn*AEDn*ATAn, where n is the level

ST=system trust metrics ranging in a discretized continuous set from [0, 1] where 1 is the highest and zero the lowest trust set. Where five levels will be defined for the range. The other layers HW, SW, AI and Supply chain follow a similar pattern.

Configurations herein consider if a set of security metrics were well defined and covered a complete robotic system. A map of a robot system breaks down the different layers into system, hardware, software, cognitive layer, and supplier chain to provide a holistic security view. System level trust metrics are difficult and complex, and several research papers scaled the problem to a small set of components or just a specific area of a system. Table I is a summary of the findings that cover a holistic system trust model.

TABLE I

| Trust Level | Trust Metric Recommendation | Values |
|---|---|---|
| System | EAL 1 to 5 | [0, 1] |
| Hardware | Hardware Component | [0, 1] |
| Software | Base Impact | [0, 1] |
| AI Robustness | Distance Metric | [0, 1] |
| Supply Chain | NG Scorecard | [0, 1]\| |

Configurations herein rely on Bayes Inference as the correct choice to build on, since it provides several benefits to overcome uncertainties for a complex system like an autonomous robotic system. By using Bayesian Inference, we also remove the intractable problem to a computational feasible one. In general terms, a Bayesian network (also known as a Bayes network, Bayes net, belief network, or decision network) is a probabilistic graphical model that represents a set of variables and their conditional dependencies via a directed acyclic graph (DAG).

Bayesian Networks use the Bayes rule in that P(a|b) is the posterior, or degree of belief in a given b. Likewise, P(b|a) is the likelihood that the event will happen given that a has happened. In our context, P(a) is the prior or initial evidence accumulated about event a, and P(b) is the marginal probability of observing the evidence. This marginal probability, P(b), acts like a normalization constant. This can be restated as Posterior=Likelihood*Prior/Evidence and is the familiar Bayes Rule:

$$P ( a \vert b ) = \frac{P ( b \vert a ) P ( a )}{P ( b )}$$

Configurations herein demonstrate metrics that allow taking a holistic security view which included system, hardware, software, cognitive trust, robustness, and supplier layers in an autonomous robotic system design.

A BN implementation defines an internal assurance model by focusing on different layers called system, hardware, software, AI robustness and supply chain vendor(s). In combination, these layers make up a holistic model of the security architecture that is incorporated into a Bayesian Network. It is proposed that this approach is superior given the alternative of simply relying on the OS to determine the security posture of the system. The OS is a large attack surface and is prone to a number of vulnerabilities. Most OS s do not support the concept of resiliency where under attack concern features shutdown to not allow the system to still function in some capacity. In the Bayesian Model we have separated each of the layers to have their own individual scores, but they are coupled together to provide a system assurance level that is dependent on the security features.

Configurations herein employ a Bayesian Network implementing a Probabilistic Graphical Model (PGM) that represent the qualitative and quantitative relationships between a set of variables or nodes in a model structure. In this PGM model, arrows represent relationship dependencies between nodes, and each node contains probability distributions, or conditional probability tables (CPTs), that are used to represent the qualitative strength of those dependencies. Both qualitative and quantitative information can be used to define the probability distributions captured in the CPTs.

A conditional probability is the probability of event A occurring, given on a condition that event B occurred. The joint probability is the probability of events A and B happening simultaneously. A CPT is the decomposed representation of the joint probabilities and is used to display the conditional probabilities. There are different methods for developing the quantitative values for each node's random values and these are represented in the CPT. A node's random value can be either discrete or continuous, for example a discrete value can be T or F, which may represent a probability of 0.5 of either value occurring. The sum of the probability values of the possible outcomes must equal 1, whereas a continuous value is a range of values between [0,1], where 0≤value≤1. These values can be acquired from domain experts, elicitation from domain users (interviews, case studies, and observations), and/or data driven (machine learning).

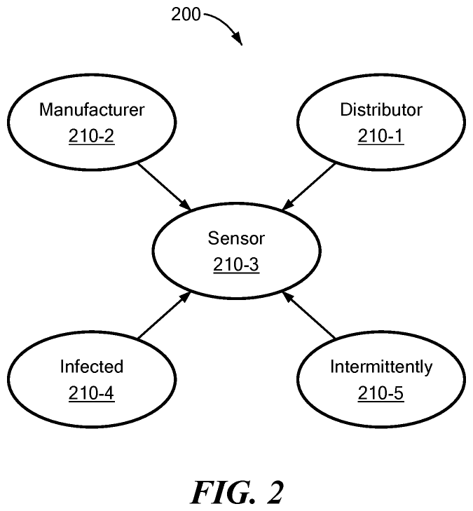

FIG. 2 shows an example of a set of nodes defining a BN 200. Referring to FIG. 2, the nodes Distributor (D) 210-1, Manufacturer (M) 210-2, Sensor (S) 210-3, Infected (I) 210-4 and Intermittently Operating (IO) 210-5 are represented in the joint distribution for probability (P) as:
P (M, D, S, I, IO)=
P (M), P (M|D), P (S| M, D), P (I| S, M, D), P (IO| S, M, D)
   FIG. 2 presents two casual cases, where the manufacturer, distributor and sensor nodes create a common effect and sensor, infected and intermittently operating create a common cause. These two cases were covered above where influence flow can be active or inactive depending on which nodes are observed.

Applying the chain rule, the joint distribution reduces to the following:
P (M, D, S, I, IO)=
P (M), P (D), P (S| M, D), P (I| S), P (IO| S)

The local Markov property means that each variable is conditionally independent of its non-descendants given its parent variables. In the case of D and M they are D⊥M since D is a non-descendant of M and the reverse is also true. In the case of I being independent since S is the parent and D and M are non-descendants, so I⊥D, M| S is true. In the case of IO being independent since S is the parent and D and M are non-descendants, so IO⊥D, M| S is true.

In a practical implementation, the model deployed in an autonomous robotic system would receive, from one or more sensors, a signal indicative of an intrusion, and would evaluate, at one of the nodes, the signal. A transition to the successive node would occur based on a result of the evaluation.

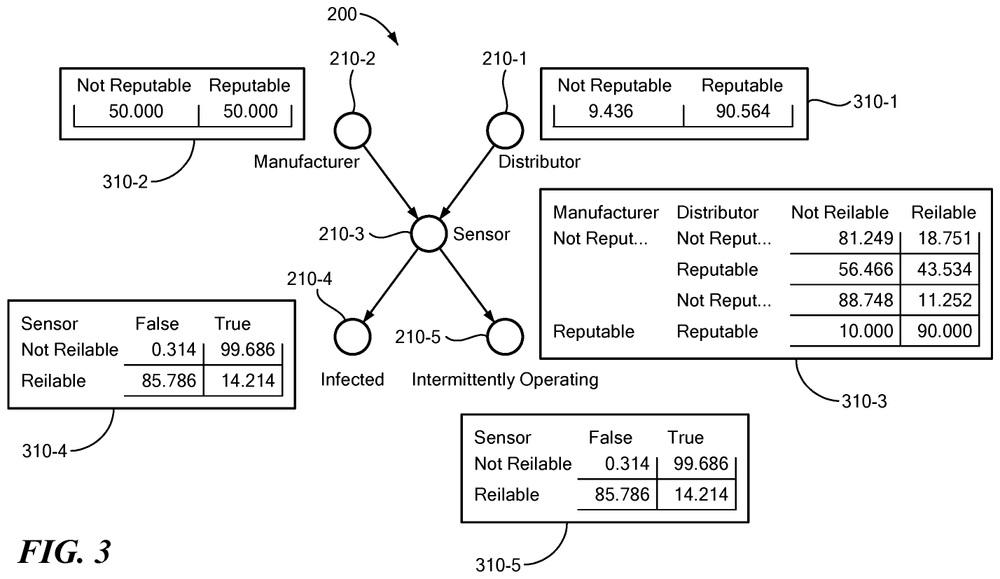

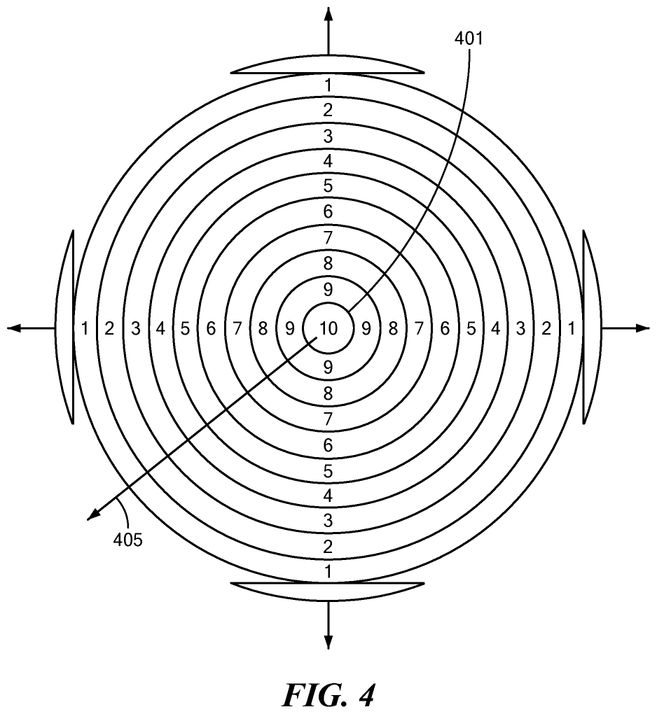

FIG. 3 shows the sensor example of FIG. 2 with a CPT defined for each node.

In large BNs the joint probability distribution of the model is equal to the probability of X given its parents (equation above) this reduces the computation since most nodes have fewer parents relative to the overall network. In other words, the full joint distribution needs Kⁿ parameters, where K is the number of values for the variable and n is the number of variables in the BN. This means that the network grows linearly, for n variables, the order of magnitude is expressed as O(m Kⁿ) vs O(Kⁿ) for a BN having m(parents)<n (variables). This compact representation makes the computation problem tractable.

Back to referencing FIG. 2, we expand on this network to formulate a BN with initial CPT values as an example of bringing the pieces together as shown in FIG. 3. Each node may include a CPT indicative of a transition to a successive node, the CPT generated based on the intrusion probability corresponding to the level on which the node resides. FIG. 3 shows a CPT 310-1 . . . 310-5 (310 generally) corresponding respectively to the nodes 210-1 . . . 210-5. We combine the types of reasoning discussion with this illustration below. The values in each CPT illustrate an example, which covers diagnostic, predication, intercausal, and combined reasoning. On the bottom of FIG. 3, variables covering Infected 310-4 and Intermittently Operating 310-5 have both the same set of values and on top Manufacturer and Distributor are slightly different with a bias toward reputable for Distributor 210-1. The sensor node 210-3 is the conditional dependency of Manufacturer and Distributor values for the sensor in a reliable or not reliable set of states. In actuality it is important to choose these values from experts or good sources, since the bias of reasoning is built on this foundation.

To construct this holistic security model that incorporates the elements discussed above, we utilize a BN that uses empirical data for its CPT values. In order to construct a BN, we need the values for the CPT of each node. To acquire these values, we use our previous results where we identified sources for assessing trust at the system, hardware, software, AI robustness, and supply chain levels. We take those values and formulate our own metrics, that include the impact, cost of damage and perceived target cost for each layer of the system. These metrics will become the basis for the CPT 310 of each node in the BN 200.

A generic equation for calculating the trust metric for each layer, is defined by the following equation:

∀x∀y∀z∀α at (x,y,z,αTMn)=>L(xn)\hat{ }R(yn)\hat{ }D(zn)\hat{ }A(αn)
Where:

$$\{ \begin{matrix}0 \leq x \leq 1 \\ 0 \leq y \leq 1 \\ 0 \leq z \leq 1 \\ 0 \leq α \leq 1\end{matrix}$$

trust metric=level value ₙ* probability of adversary exploit reward ₙ* probability of adversary exploit damage ₙ* likelihood of adversary taking action ₙ
   Where the level value can be constructed from a number of parameters specific to that layer and n defines the levels associated with each of the parameters. For example, a level value can be high, adversary exploit reward can be high, the adversary exploit damage can be high, but the adversary taking action to exploit may be low. The trust metric parameters are independent of each other, but for simplicity in the tables below the parameters will be aligned with the associated levels. This means that when the level value is high, each of the remaining parameters will be high. The likelihood for an adversary taking action to exploit will not be shown in the calculations below, since this is being kept at a probability of 1 for the rest of the discussion. The probability of 1 represents that the adversary will also try to exploit. By applying to a plurality of levels, the BN may then, for each level, denote one or more nodes, such that each node represents a variable concerning an intrusion and a causal relation to at least one other node. The causal relation being either a cause or effect of an intrusion based on the variable, and extending to a causation chain depending on the number and relations among the nodes.

The resulting BN 200 therefore encompasses plurality of levels in the autonomous system, each level susceptible to an intrusion. The BN model designates, for each node, a level, the level indicative of an intrusion point in the autonomous system, the levels including system, hardware, software, AI robustness and supply chain, as shown in Table I. Other levels may also be derived. Developing the BN includes, for each level, determining an intrusion probability associated with an attack directed to the respective level, the probability based on:
i) an assurance value of the level,
ii) a potential reward to an adversary,
iii) a probability of adversary exploit damage, and
iv) a probability of an adversary taking action to exploit.

The model first defines the equation for the system metric:

SysScore(n)=(Eₙ*Cₙ*Tₙ*CDPₙ*PTVₙ*Lₙ)

Where En is the common criteria evaluation assurance level (EAL), Cn is the cost for development to achieve that level n, Tn is the time it takes to achieve that level, CDP is the Collateral Damage Potential that an adversary can cause from an exploit, PVT is the Perceived Target Value is the reward that an adversary can gain from the exploit and L is the likelihood that an adversary will exploit. The cost and time variables are controlled by the assurance level being targeted, the deliverables to meet the requirements, the gates for verification/validation, independent 3^{rd} party lab for validation and by the certifying entity.

At the system level of trust metrics, we will use the first five levels of common criteria specification since it provides a basis for assigning values that is widely known and used to evaluate system security trust.

The values for the Collateral Damage Potential are shown in Table II:

TABLE II

| Metric | Value | Description |
|---|---|---|
| None | 1 | There is no potential for loss of life, physical assets, |
| | | productivity, or revenue. |
| Low | 1.25 | Successful exploitation of this vulnerability may result |
| | | in slight physical or property damage or loss. Or there |
| | | may be a slight loss of revenue or productivity. |
| Low- | 1.5 | Successful exploitation of this vulnerability may result |
| Med | | in moderate physical or property damage or loss. Or |
| | | there may be a moderate loss of revenue or |
| | | productivity. |
| Med- | 1.75 | Successful exploitation of this vulnerability may result |
| High | | in significant physical or property damage or loss. Or |
| | | there may be a significant loss of revenue or |
| | | productivity. |
| High | 2 | Successful exploitation of this vulnerability may result |
| | | in catastrophic physical or property damage or loss. Or |
| | | there may be a catastrophic loss of revenue or |
| | | productivity. |

Table III shows perceived target values, or the value an infiltrator expects from the intrusion:

TABLE III

| Metric | Value | Description |
|---|---|---|
| None | .4 | The targets in this environment are perceived as no value by |
| | | attackers. Attackers are not motivated to attack the target system. |
| Low | .6 | The targets in this environment are perceived as low value by |
| | | attackers. Attackers have low motivation to attack the target |
| | | system relative to other systems with the same vulnerability. |
| Low- | .8 | The targets in this environment are perceived as low to medium |
| Med | | value by attackers. Attackers have low to medium motivation to |
| | | attack the target system relative to other systems with the same |
| | | vulnerability. |
| Med- | 1 | The targets in this environment are perceived as medium to high |
| High | | value by attackers. Attackers are equally motivated to attack the |
| | | target system and other systems with the same vulnerability. |
| High | 1.2 | The targets in this environment are perceived as high value by |
| | | attackers. Attackers are highly motivated to attack the target system |
| | | relative to other systems with the same vulnerability. |

Table IV is the likelihood of the adversary taking action to exploit. The likelihood is a function that a threat exists and that the threat can successfully exploit the component or system.

TABLE IV

| Metric | Value | Description |
|---|---|---|
| None | .2 | |
| Low | .4 | The likelihood of the adversary taking action to |
| | | exploit is low |
| Low- | .6 | |
| Med | | |
| Med- | .8 | |
| High | | |
| High | 1 | The likelihood of the adversary taking action to |
| | | exploit is high |

It is significant to normalize the table values to a range of 0.0-1.0.

Individual scores are computed for each of the levels in succession. For the hardware level, this may include generating a hardware score based on a hardware design trust metric, a collateral damage resulting from the intrusion, a potential reward to an adversary and likelihood of an adversary taking action to exploit.

An equation for the hardware metric is shown below:

HWScore(n)=(TMₙ*CDPₙ*PTVₙ*Lₙ)

Where TMn is the hardware design trust metric, CDP is the Collateral Damage Potential that an adversary can cause from an exploit and PTV is the Perceived Target Value is the reward that an adversary can gain from the exploit. Table V shows a resulting hardware metric:

TABLE V

| Metric | Value | Description |
|---|---|---|
| None | 0 to .15 | Where this is the lowest trust level, |
| | | damage, and reward to exploit |
| Low | .16 to .33 | |
| Low- | .34 to .51 | |
| Med | | |
| Med | .52 to .70 | |
| Med- | .71 to .89 | |
| High | | |
| High | .9 to 1 | Where this is the highest trust |
| | | level, damage, and reward to |
| | | exploit |

For the software level, the metric includes generating a software score based on a technical impact from an intrusion, a collateral damage resulting from the intrusion, a potential reward to an adversary and a and likelihood of an adversary taking action to exploit. A software metric is defined as follows:

SWScore(n)=(TIₙ*CDPₙ*PTVₙ*Lₙ)

Where TIn is the Technical Impact from a potential software vulnerability, CDP is the Collateral Damage Potential that an adversary can cause from an exploit and PTV, the Perceived Target Value is the reward that an adversary can gain from the exploit. A resulting table for the software metric is shown in Table VI.

TABLE VI

| Metric | Value | Description |
|---|---|---|
| None | 0 to .35 | Where this will indicate no impact, no damage, |
| | | and no reward for exploit. |
| Low | .36 to .53 | Where this will indicate low value to impact, |
| | | damage, and reward for exploit |
| Low- | .54 to .71 | Where this will indicate low value to impact, |
| Med | | damage, and reward for exploit |
| Med- | .72 to .89 | Where this will indicate high medium value to |
| High | | impact, damage, and reward for exploit |
| High | .9 to 1 | Where this will indicate high value to impact, |
| | | damage, and reward for exploit. |

for the supply chain level, the approach generates a supplier score based on a supplier trust metric, a collateral damage resulting from the intrusion, a potential reward to an adversary and likelihood of an adversary taking action to exploit. An equation for the supplier metric as shown as follows, where Supn is the supplier trust metric, CDP is the Collateral Damage Potential that an adversary can cause from an exploit and PTV is the Perceived Target Value is the reward that an adversary can gain from the exploit.

SupScore(n)=(Supₙ*CDPₙ*PTVₙ*Lₙ)

The resulting supplier metric table is shown in Table VII.

TABLE VII

| Metric | Value | Description |
|---|---|---|
| Unsatisfactory | 0 to .51 | Where this will indicate unsatisfactory rating |
| | | level of trust, damage, and reward to exploit. |
| Marginal | .52 to .70 | Where this will indicate the minimal level of |
| | | trust, damage, and reward to exploit. |
| Satisfactory | .71 to .89 | Where this will indicate the next highest |
| | | level of trust, damage, and reward to exploit. |
| Excellent | .9 to 1 | Where this will indicate the highest level of |
| | | trust, damage, and reward to exploit. |

The preceding discussion makes clear that AI introduces different types of possible attack vectors. The focus is on AI adversarial attacks (intrusions), the classification of data being poisoned, evasion attacks and black box attacks to name a few. For every attack, a remedy may arise to counter, but this takes time and there needs to be a method to identify these types of attacks. In the case of autonomous mobile robots, an AI/learning layer makes a system susceptible to new types of attack strategies which more conventional attacks may not consider. For the AI robustness level, an AI robustness score is generated based on a distance function of an AI implementation employed, a collateral damage resulting from the intrusion, a potential reward to an adversary and likelihood of an adversary taking action to exploit. This leads to a different approach that was taken with the AI robustness calculations since the approaches for evaluating AI robustness are very different than those used at the system, hardware, software, and supply chain metrics. An adversarial example is when x is recognized and classified as the original as target t=arg-max F(x) and a new desired target where t′ not equal to t, this is called x′ a targeted adversarial example if arg-max F(x′)=t′ and x′ is close to x given a distance metric. The minimum distance of a misclassified nearby adversarial example to x is the minimum adversarial distortion required to alter the target model's prediction, which is referred to as the lower bound. A certified boundary guarantees the region around x that the classifier decision cannot be influenced from all types of perturbations in that region. In other words, the robustness is being able to detect perturbation as close to x as possible and, in some cases, this is an approximation or an exact guarantee to determining the lower boundary point. In order to evaluate the distance, sometimes called distortion or error, between x′ and x, the generalized Minkowski's formula is used to calculate the distance metric within p-norm space. The generalized form calculates the distance metric for p-norm when p=1, is a Manhattan distance, when p=2 it is a Euclidean distance, and when p=∞ it is a Chebyshev distance, the distance formula represents a generalized approach for distance measurements.

$$D ( X , Y ) = {( {\sum }_{i = 1}^{n} {\vert {x}_{i} - {y}_{i} \vert}^{p} )}^{\frac{1}{p}}$$

By using these lower bound techniques, a minimum distortion level is established and from this point we can define ranges for rating AI implementations against these known values. FIG. 4 depicts a distance metric for robustness. Referring to FIG. 4, to better illustrate this distance concept, FIG. 4 shows a center region 401 equal to the certified region and each subsequent ring is correlated to the rating or strength of the AI implementation using a distance function 405. Let x be the certified region and y be the AI implementation, we can use the p-norm distance equation to determine the differences for adversarial perturbation detection.

The AI Robustness metric as shown below, Where Dn is the distance from the lower bound (certified area) of detecting an adversarial attack. As the distance is closer to the certified area it becomes more difficult to detect, therefore, resulting in higher risk. The supplier must provide the testing results where these distance values can be obtained from or provide the testing logic, so that others can validate these values. CDP is the Collateral Damage Potential that an adversary can cause from an exploit and PTV, the Perceived Target Value is the reward that an adversary can gain from the exploit.

airScore(n)=(Dₙ*CDPₙ*PTVₙ*Lₙ)

The resulting AI robustness metric is shown in TABLE VIII

TABLE VIII

| Metric | Value | Description |
|---|---|---|
| None | 0 to .30 | Where this will indicate farthest away, no damage |
| | | and no reward for exploit. |
| Low | .31 to .49 | Where this will indicate low value for robustness, |
| | | damage, and reward for exploit |
| Low- | .50 to .71 | Where this will indicate low medium value for |
| Med | | robustness, damage, and reward for exploit |
| Med- | .72 to .89 | Where this will indicate high medium value for |
| High | | robustness, damage, and reward for exploit |
| High | .9 to 1 | Where this will indicate high value for robustness, |
| | | damage, and reward for exploit |

The AI robustness metric introduces the distance formulas into determination of a trust metric. Each defense technique has a distance/error from the certified area (boundary) where perturbations can be detected, we can consider these values as trust metrics in a continuous set of ranges between [0,1]. Unlike some of the other measures we have seen so far that this is still an area that is less mature but apply the same technique to derive metrics.

The collective set of metrics is then employed to derive a BN, incorporating the trust metrics as a CPT for nodes in the level corresponding to the particular trust metric Collectively these metrics above define, for each level, a score indicative of the probability of intrusion for each node on the respective level.

A Bayesian Network is preferred in the context of trust and causal inference, is part of reasoning. By using causality, several questions can now be asked about the security posture of an autonomous robot system using BNs, but most importantly the robotic system can act on the knowledge it has from an internal point of view. Some questions to postulate against are: does having vendors that are more reliable than others decrease risk; do manufacturers that follow a security-aware development process reduce risk vs ones that do not; and if the platform supports a specific security configuration, can it be trusted to process an increased level of sensitive information? In the mrthod to create a BN, we have completed the quantitative portion by defining the metrics for our CPTs in the previous section and now we start to define the nodes of the BN is this section. We use a research platform for creating and analyzing the causality of the Bayesian Network.

The models and simulations are created in a product called BayesiaLab™. BayesiaLab is a graphical desktop application that can run on mainstream platforms and it provides functions like supervised machine learning, unsupervised machine learning, knowledge modeling, observational inference, casual inference, diagnosis, analysis, simulation, optimization, and visualization in 2D/3D formats. Formulas can be utilized as well as different probability distributions.

The methodology for assessing assurance involves applying an assurance score and a reputation score at each level of the system, so that the child layer has knowledge about its parent layer. The assurance score utilizes the trust metrics defined earlier, which includes the reward and damage values for each of the components that make up the system. The reputation score reflects a value to account for errors that may arise during the bootup of the system or during operational state execution. The collective assurance score is used by the system to assess external requests in order to properly fulfill it in a secure manner. This also reflects on the security posture of the system, meaning can the system support the request from a security point of view if the system is configured correctly to support the request and what are the potential risks. Utilizing the assurance and reputation scores goes deeper into the security model then the authentication/authorization controls that are used in conventional systems today.

FIG. 2 depicts a small example of a Bayesian Network, described the autonomous robotic system security features. Using the metrics above, this is expanded to correspond to internal layers of the autonomous robotic system. There are a number of steps or guidelines that need to be taken in order to construct a BN for a security assessment. First, create the corresponding nodes for the hardware components of a robotic system. This should include the hardware design and vendor metrics for each of the components. The next step is to add the software nodes to the BN model, this also includes the software and vendor metrics. If security features are supported, they must also be included as part of hardware and software components. If Cognitive/AI components are supported, these nodes should be layered in the model above the OS layer. An AI vendor should provide robustness parameters, but in the event they do not, they should provide testing models/dataset so that one can obtain them from running validators.

The accuracy, supervisor, and maintenance layers will need to be defined by the underlying hardware/software/security features. Once the model is constructed and the nodes are defined with their corresponding CPT values, one can start to set the appropriate evidence for the nodes. By defining an assurance level of a target node, the BN model can be used to simulate the outcomes of the evidence set on the nodes or using the optimization technique as discussed above, they could set the desired values to obtain the results. Each of the layers should have a corresponding assurance level, so that by setting the security features as evidence on several nodes, this in turn will change the other nodes. By running the simulation, the result on the target node will change to the level that was selected. A target node is considered a dependent variable in traditional modeling approaches.

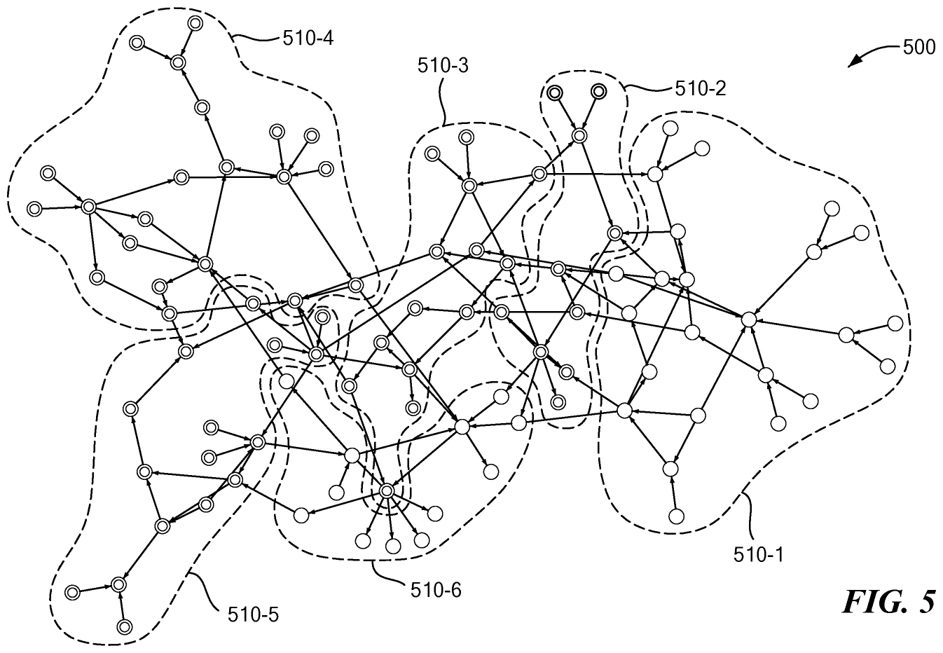

FIG. 5 depicts an example BN 500 that applies the trust metrics of Tables II-VIII. In FIG. 5, the nodes of the BN are assigned a level; the node is assessed based on the metric for that level. Any suitable number and granularity of levels may be assessed; the examples herein depict metrics as outlined in Table I. FIG. 5 shows a similar arrangement of layers applies to the BN 500. In FIG. 5, nodes are grouped according to layers of firmware 510-1, operating system 510-2, cognitive/services 510-3, robotic control system and AI 510-4, maintenance 510-5, and offensive/defensive or supervisor control 510-6.

The assurance score and a reputation score are propagated into each level 510 so that the child layer has knowledge about its parent layer. These scores can be used to control the overall assurance level for the system. For example, a robot that needs to support a high assurance level, high loss of damage and high reward to exploit would select each of the layers to a high assurance score. Of course, the assurance scores are based on the physical hardware and what security features are enabled. To add additional assurance at the platform and accuracy layers a set of fault tolerant features can be enabled. Once the security posture is assumed to be a specific level, the offense and defense controller can take actions on a process that it has determined is abnormal. The cognitive layer interacts with the offense/defense controller to ensure that the system can function within certain limits. The internal state of the system must be sound and known if external interaction is to take place, the external request can be scrutinized and therefore, extend the trust model with the entity. Having the supply chain vendors also being part of the system model helps establish the pedigree of the components.

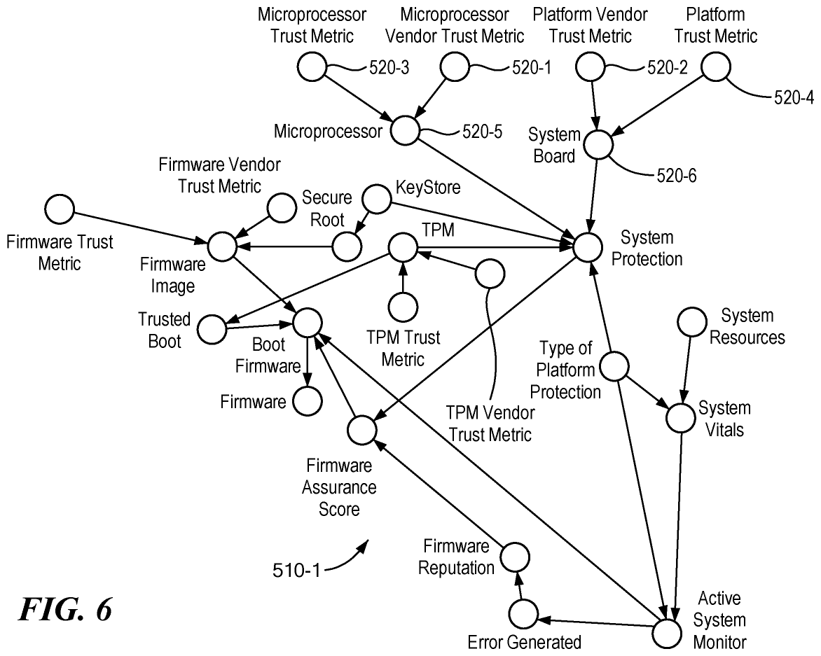

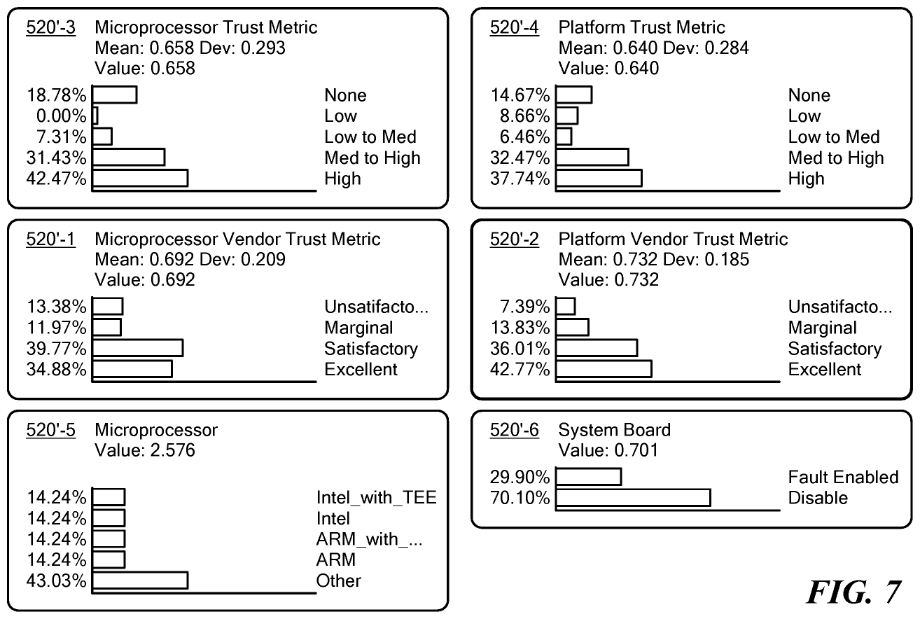

An example using the firmware layer follows. FIG. 6 depicts the nodes in the firmware layer 510 of FIG. 5. Referring to FIGS. 5 and 6, the firmware layer is the very first layer of the system stack where hardware and software interact when power is applied to the system. In this example, we assume that the system vendor has loaded initialization and personalization values into the system at a secure manufacturing site to achieve high assurance levels. The firmware layer nodes therefore represent system, hardware, software, and supplier entities.

Illustrating the node dependencies, we have a supplier vendor 520-1, 520-2 and the hardware design 520-3, 520-4 metrics for the microprocessor 520-5 and the system board 520-6. The set of nodes for the microprocessor and system board are both common effects. The microprocessor 520-5 was introduced in the example above, but in the context of the larger BN the ability to differentiate the types of processor is needed. Here we defined the Intel TXT and AMD Trusted Zone as having a higher security level than regular Intel and AMD processor types. We have an “other” field for all other types of processors. The system board represents the supported feature of fault tolerance. FIG. 7 shows examples of transitions 520′-1 . . . 520′-6 (520′ generally), or CPTs, for the respective nodes.

During deployment or production, the developed model can be applied to an autonomous robotic system for ongoing evaluation of intrusion detection. The autonomous system generates a set of nodes, such that each node of the set of nodes is indicative of a relevant state as described above, and following an input or event, identifies a set of nodes indicative of a successive state. An intrusion is indicated by a substantial or threshold deviation from a previous, “trusted” state of normal operation. The model is invoked for comparing the generated set of nodes with the nodes indicative of the successive state to identify a probability of a security intrusion.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for internal cognitive assurance of an autonomous system, comprising:
developing a model for identifying a transition from a prior machine state to a current machine state;
deploying the model in an autonomous system; and
evaluating a probability that the current machine state is indicative of a breach.

2. The method of claim 1 wherein developing the model further comprises:
generating a set of nodes, each node of the set of nodes indicative of a relevant state;
identifying a set of nodes indicative of a successive state; and
comparing the generated set of nodes with the nodes indicative of the successive state to identify a probability of a security intrusion.

3. The method of claim 1 wherein the model includes a Bayesian Network (BN).

4. The method of claim 1 wherein the autonomous system includes an untethered robotic element in free space.

5. The method of claim 1 further comprising a plurality of levels in the autonomous system, each level susceptible to an intrusion.

6. The method of claim 2 further comprising designating, for each node, a level, the level indicative of an intrusion point in the autonomous system, the levels including system, hardware, software, AI robustness and supply chain.

7. The method of claim 6 further comprising, for each level, determining an intrusion probability associated with an attack directed to the respective level, the probability based on:
i) an assurance value of the level,
ii) a potential reward to an adversary,
iii) a probability of adversary exploit damage, and
iv) a probability of an adversary taking action to exploit.

8. The method of claim 6 further comprising:
receiving, from one or more sensors, a signal indicative of an intrusion;
evaluating, at one of the nodes, the signal; and
computing a transition to the successive node based on a result of the evaluation.

9. The method of claim 6 further comprising, for each level, denoting one or more nodes, each node representing a variable concerning an intrusion and a causal relation to at least one other node, the causal relation being either a cause or effect of an intrusion based on the variable.

10. The method of claim 6 wherein each node includes a CPT (Conditional Probability Table) indicative of a transition to a successive node, the CPT generated based on the intrusion probability corresponding to the level on which the node resides.

11. The method of claim 10 further comprising defining, for each level, a score indicative of the probability of intrusion for each node on the respective level.

12. The method of claim 6 further comprising, for the system level, generating a system score based on the assurance value of the system level, a cost for development to achieve that level, a time taken to achieve the level, a collateral damage resulting from the intrusion, a potential reward to an adversary, and a likelihood of an adversary taking action to exploit.

13. The method of claim 6 further comprising, for the hardware level, generating a hardware score based on a hardware design trust metric, a collateral damage resulting from the intrusion, a potential reward to an adversary and likelihood of an adversary taking action to exploit.

14. The method of claim 6 further comprising, for the software level, generating a software score based on a technical impact from an intrusion, a collateral damage resulting from the intrusion, a potential reward to an adversary and a and likelihood of an adversary taking action to exploit.

15. The method of claim 6 further comprising, for the supply chain level, generating a supplier score based on a supplier trust metric, a collateral damage resulting from the intrusion, a potential reward to an adversary and likelihood of an adversary taking action to exploit.

16. The method of claim 6 further comprising, for the AI robustness level, generating an AI robustness score based on a distance function of an AI implementation employed, a collateral damage resulting from the intrusion, a potential reward to an adversary and likelihood of an adversary taking action to exploit.

17. A autonomous robotic system including a cognitive assurance model for intrusion detection, comprising:
a memory configured for storing nodes and relations in a Bayesian network (BN);
storing, in the memory, a model for identifying a transition from a prior machine state to a current machine state;
developing the model, further comprising:
generating a set of nodes, each node of the set of nodes indicative of a relevant state;
identifying a set of nodes indicative of a successive state; and
comparing the generated set of nodes with the nodes indicative of the successive state to identify a probability of a security intrusion; and
evaluating a probability that the current machine state is indicative of a breach.
